(19) United States
(12) Patent Application Publication
(10) Pub. No.: US 2002/0184640 A1
(43) Pub. Date: Dec. 5, 2002

(54) Remote controlled marine observation system

(76) Inventors: Robert Alan Schnee, Flower Mound, TX (US); Tommy Dean Wright, Irving, TX (US)

Correspondence Address: Thomas C. Wright, Sanford E. Warren, Jr., GARDERE WYNNE SEWELL LLP, 1601 Elm Street, Suite 3000, Dallas, TX, 75201, US

(21) Appl. No.: 09/871,244

(22) Filed: May 31, 2001

(51) Int. Cl. H04N 7/18

(52) U.S. Cl. 725/105; 348/162; 348/164; 348/143

(57) ABSTRACT

An observational apparatus has a remote controlled housing that can be controlled proximate the housing or from various points around the world via a global communications network. A camera cluster mounted to the remote controlled housing has a signal output. A monitor to receive the signal output can be located proximate the remote controlled housing or distant from the remote controlled housing.

### FIELD OF THE INVENTION

The present invention relates to observation systems and, more particularly to, a remote controlled system to monitor and navigate a marine vessel in a variety of environmental conditions.

### BACKGROUND OF THE INVENTION

Marine vessels can cost from several thousand dollars to several million dollars. The owners of these vessels, consequently, have an interest in protecting the vessels and their contents from loss. Maritime loss typically occurs because a vessel strikes an object or intruders, such as vandals or thieves, target the vessel.

Many objects such as other boats, small islands, floating debris, or docks, for example, are hazards that may cause damage to a vessel. Nighttime or foggy conditions further increase the possibility that a vessel will strike one of these hidden hazards. Nightvision, radar and low-light video systems have been used to help navigate vessels but none of these systems offer an effective solution for the multitude of adverse conditions that a vessel may encounter.

Additionally, these systems are typically useless against intruders. Intrusion may occur while a vessel is at sea or while the vessel is docked at port. A vessel is most susceptible to intruders at sea during the night because a vessel may be anchored and the passengers and crew are usually sleeping. Although intruder attacks may be especially dangerous if passengers and crew are on board, the potential for loss when the vessel is not manned is also great. Regardless of whether the vessel is at sea or at port, most navigation systems lack the ability to monitor the vessel to warn the owner, crew or passengers of intruders or other security threats to the vessel.

Owners may also simply want to monitor their vessel for entertainment or information. For example, the vessel may be berthed in the Bahamas while the owner is working in Dallas. During breaks from work, the owner may be interested in viewing the vessel as a diversion. The owner may also need to monitor activities on the vessel if, for example, the crew is performing a specific repair or preparation. The owner might also want to check the weather or the general condition of the vessel before departing on a vacation to the vessel. Currently available navigation systems do not allow the owner to monitor the vessel or the conditions around the vessel from a location other than on the vessel.

It would, therefore, be desirable to have observational system that is not limited to providing images in a single environmental condition. Additionally, there is a need for an observational system that is not powerless against intruder attacks. There is also a need for an observational system that does not limit an owners' ability to monitor the vessel from remote locations.

### SUMMARY OF THE INVENTION

According to one embodiment of the present invention, an observational apparatus has a remote controlled housing. The remote controlled housing can be controlled proximate the housing or from various points around the world via a global communications network. A camera cluster mounted to the housing has a signal output. A monitor to receive the signal output can be located proximate the housing or distant from the housing.

According to another embodiment of the present invention, a system for monitoring a marine vessel has a remote controlled gimbal mount. A camera cluster is attached to the gimbal mount. A remote monitor displays an image captured by the camera cluster.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a perspective view of a marine vessel having an observation system according to one embodiment of the present invention; and

FIG. 2 is a block diagram of an observation system that depicts an embodiment of the present invention.

### DETAILED DESCRIPTION OF THE INVENTION

Although making and using various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

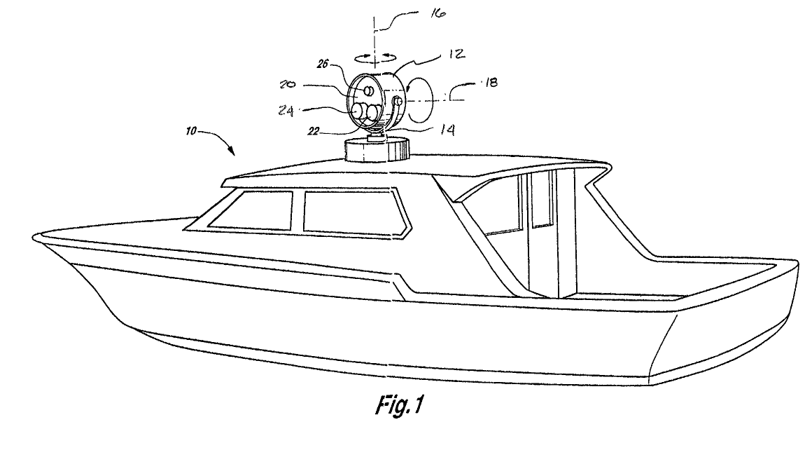

Referring to FIG. 1, a marine vessel 10 has a housing 12, which may be mounted to an elevated surface of the marine vessel 10. Although this embodiment of the invention is described in conjunction with the marine vessel 10, the housing 12 may also be mounted to other vessels such as airplanes or recreational vehicles, or to stationary structures such as homes, buildings, restaurants, or vacation properties, for example.

The housing 12 may be aimed in any direction an operator desires. One or more motors (not shown) may tilt and pan the housing 12 through a range of motion. A gimbal mount 14 allows the housing 12 to be moved about or along one or more axis. For example, the housing 12 may be panned about a vertical axis 16 or tilted about a horizontal axis 18. The housing 12 may also be raised or lowered along the vertical axis 16 to change the elevation of the housing 12. The housing 12 may also be moved along a z-axis (not shown), which may be generally normal to the horizontal axis 18. For example, if an operator wants to aim the housing 12 over the gunwale of the marine vessel 10, the housing 12 may be extended along a boom (not shown) and rotated into the desired orientation.

A camera cluster 20 may be mounted within the housing 12. The camera cluster 20 and housing 12 may be waterproof and weatherproof according to a particular application. The camera cluster 20 may also have damping and vibration isolation members (not shown) to prevent damage to the camera cluster 20 and improve operation in rough conditions.

The camera cluster 20 may have one or more cameras 22, 24. For example, the camera cluster 20 may include a conventional analog video camera, a digital video camera, a low-light video camera, an infrared camera or other night vision device, or a combination of one or more of these cameras 22, 24 for example. The cameras 22, 24 may capture an image individually or a lens 26 may capture the image and distribute the image to one or more of the cameras 22,24 in the camera cluster 20.

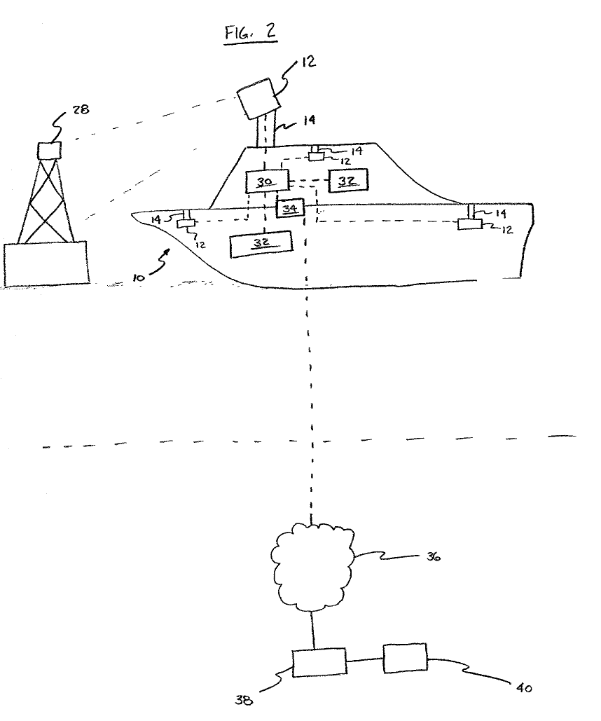

Referring now to FIG. 2, a block diagram depicts how components of one embodiment of the invention may interact to observe an object 28. The object 28 may be a buoy, a natural obstacle or hazard, storm clouds, another marine vessel, an intruder, or the scenery around the vessel 10, for example. The cameras 22,24 in the camera cluster 20 may capture one or more images of the object 28. The image or images of the object 28 may be transmitted to a computer processor 30.

The computer and/or processor 30 may control the orientation of the housing 12 and the operation of the cameras 22, 24 within the camera cluster 20. For example, an operator may instruct the computer processor 30 to operate the housing 12 from a remote control console 32. The operator may tilt, pan, raise, lower, or extend the housing 12 from the remote console 32. The operator may also select an image from an individual camera 22, 24 or fuse images from multiple cameras 22, 24.

The computer processor 30 may also perform other tasks for safety and convenience. For example, the computer processor 30 may analyze and evaluate multiple images from the camera cluster 20. The computer processor 30 may then select the best available image to transmit to the console 32. The computer processor 30 may also fuse multiple images from the camera cluster 20 and send a fused image to the console 32. In certain lighting conditions, a fused image may provide the operator with an image of the object 28 that has better resolution or definition than an image from one of the individual cameras 22, 24.

The computer processor 30 may also automatically detect and track an object 28. Automatic tracking may allow the computer to navigate the marine vessel 10 to avoid collisions with the object 28. For security purposes, the computer processor 30 may also be configured to detect the object 28 and trigger an alarm.

For example, the computer processor 30 may be configured to detect an intruder or other object 28 while the crew and passengers are sleeping. The computer processor 30 may be configured to continuously pan the housing 12 during the night to monitor infrared radiation from an intruder, for example. If an object 28 that emits infrared radiation is located, the computer processor 30 may then track the object 28 and sound an alarm.

The console 32 may include a monitor, a keyboard, and a control device such as a joystick or a mouse, for example. The monitor may be a cathode ray tube (CRT), a liquid crystal diode (LCD) display, a digital micromirror device (DMD) display, a plasma display, for example. Multiple consoles 32 may be located throughout the marine vessel 10. The consoles 32 may be wired to the computer processor 30 or the consoles 32 may communicate with the computer processor 30 through a wireless connection such as by radio frequency (RF) or an infrared wireless transmissions or through a wireless modem 34, for example. The operator may carry a wireless console 32 as he moves about the marine vessel 10, which allows the operator to continuously monitor the object 28 and control the housing 12 while tending to other tasks.

The console 32 may provide features in addition to those described above. For example, the console 32 may be adapted to receive and display signals from sources such as a global positioning system (GPS), a weather satellite, a radar antenna, a sonar transponder, or broadcast or cable television. Images from these sources may be displayed in conjunction with images from the camera clusters 20.

The housing 12 may be remote controlled from multiple locations around the marine vessel 10 or around the world. A captain may aim and control the housing from the helm, for example, for navigational purposes. Additionally, the housing 12 may also be controlled from a cabin for general observational purposes or for security.

The housing 12 may also be controlled through a global communications network 36, such as the Internet, a cellular network, or satellite network, for example. A remote operator may activate and operate the observation system from a remote console 38, which may be connected to the computer processor 30 through the global communication network 36 and the wireless modem 34. This connection allows a user to control the operation of the housing 12 from any point where the user can access the global communication network 36.

The remote console 38 may be a personal computer in the remote operator's office, which may include a monitor 40. The monitor 40 may be a cathode ray tube (CRT), a liquid crystal diode (LCD) display, a digital micromirror device (DMD) display, a plasma display, for example.

In one embodiment, multiple housings 12, which contain individual camera clusters 20, may be mounted in various locations throughout the vessel 10. Some housings 12 may be mounted on remote controllable gimbal mounts 14 and other housings 12 may be mounted in a fixed orientation. Each housing 12 may be individually remote controlled to aim the camera cluster 20 in the desired direction. All images from the camera clusters 20 may be sent to the computer processor 30.

The computer processor 30 allows the user to select a single image from an individual camera cluster 20 or simultaneously display one or more images from one or more of the camera clusters 20. For example, a night vision image from a camera cluster 20 on the bow of the vessel 10 may be simultaneously displayed with an image from a camera cluster 20 in the engine room. The computer processor may distribute the images to one or more consoles 32 at different locations on the vessel 10. The images may also be sent to the remote console 38 and displayed on the monitor 40.

Although this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An observational apparatus comprising:
a remote controlled housing;
a camera cluster mounted to the remote controlled housing, the camera cluster having a signal output; and
a monitor to receive the signal output.

2. The apparatus of claim 1, wherein the apparatus may be controlled through a global communications network.

3. The apparatus of claim 1, wherein the camera cluster comprises a conventional video camera and an infrared camera.

4. The apparatus of claim 1, wherein the housing is mounted on a marine vessel.

5. The apparatus of claim 4, wherein the monitor is remote from the marine vessel.

6. The apparatus of claim 1, wherein the signal output is transmitted to the monitor by a wireless transmission.

7. The apparatus of claim 1 wherein the signal output is transmitted to two or more monitors.

8. The apparatus of claim 1 wherein two or more images from the camera cluster are fused into one displayed image.

9. The apparatus of claim 1 further comprising two or more camera clusters.

10. The apparatus of claim 1 further comprising a fixed camera cluster remote from the camera cluster.

11. A system for monitoring a marine vessel comprising:
a remote controlled gimbal mount;
a camera cluster attached to the gimbal mount; and
a remote monitor to display an image captured by the camera cluster.

12. The system of claim 11, wherein the gimbal mount may be controlled through a global communications network.

13. The system of claim 11, wherein the camera cluster comprises a video camera and an infrared camera.

14. The system of claim 13 wherein the video camera is a low-light camera.

15. The system of claim 11 further comprising a computer processor to control the orientation of the gimbal mount and the operation of the camera cluster.

16. The system of claim 15 further comprising a wireless modem connected to the computer processor to receive a control signal from a remote location.

17. The system of claim 11 wherein an image is distributed to each camera in the camera cluster by a single or a double lens.

18. The system of claim 17 wherein an image processor analyzes each captured image from each camera in the camera cluster and selects a captured image to transmit to the monitor.

19. The system of claim 18 wherein the image processor fuses two or more captured images into a fused image and transmits the fused image to the monitor.

20. The system of claim 11 wherein one or more captured images from one or more cameras are transmitted to a monitor remote from the marine vessel.

21. The system of claim 11 further comprising a sensor to detect a change in the image and trigger an alarm.

22. The system of claim 11 wherein the monitor displays the image using a digital micromirror device.

23. The system of claim 11 further comprising a fixed camera cluster remote from the camera cluster.

24. The system of claim 11 further comprising two or more camera clusters.

25. An observational system comprising:
a first remote controlled housing;
a first camera cluster mounted to the first remote controlled housing, the first camera cluster having a first signal output;
a second remote controlled housing;
a second camera cluster mounted to the second remote controlled housing, the second camera cluster having a second signal output; and
a monitor to receive the first signal output and the second signal output.

26. The observational system of claim 25 further comprising a third camera cluster.

27. The observational system of claim 26 wherein the third camera cluster is mounted to a third remote controlled housing.
